(19) United States
(12) Patent Application Publication
(10) Pub. No.: US 2003/0161313 A1
(43) Pub. Date: Aug. 28, 2003

(54) Router device and internet service provider selection method

(75) Inventors: Tatuya Jinmei, Kanagawa (JP); Masahiro Ishiyama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/373,719

(22) Filed: Feb. 27, 2003

(30) Foreign Application Priority Data
Feb. 27, 2002 (JP) 2002-051874

(51) Int. Cl. H04L 12/28

(52) U.S. Cl. 370/392; 370/401

(57) ABSTRACT

At a router device capable of accessing a plurality of Internet service providers that provide services for accessing Internet, a probe packet destined to a prescribed address on the Internet is transmitted via each Internet service provider, a response packet in response to the probe packet is received, and accessibility of each Internet service provider is judged according to a result of receiving the response packet. Then, information indicating the accessibility of each Internet service provider is stored, and one of the Internet service providers through which a received packet should be routed is selected according to the information indicating the accessibility, upon receiving a packet that can be routed via more than one Internet service providers.

### BACKGROUND OF THE INVENTION

1. Field of the Invention

The present invention relates to a router device and an Internet service provider selection method to be used at a site capable of accessing a plurality of Internet service providers.

2. Description of the Related Art

The world largest computer network called “Internet” has become widespread and there is now an environment in which the Internet is widely accessed from ordinary homes to small size offices. Such general Internet users normally access the Internet through the accessing business companies called Internet Service Providers (ISP).

In order to secure the more stable accessibility, to realize the load balancing among channels, there are also sites which have a plurality of channels for accessing the Internet by contracting a plurality of Internet Service Providers simultaneously. Such an access style is generally referred to as a multi-home. As the Internet users have increased, the access fee and the channel fee are decreasing so that the multi-home users are increasing.

Under the multi-home environment, in order to achieve the stable accessibility by taking advantage of its redundancy, there is a need to know the network environment inside the ISP in detail. For example, suppose that some ISP “xxx” has a partially disabled network which has lost a reachability to some destinations. In the case where a site that is under the contract with this ISP “xxx” is under the multi-home environment in which there is also an accessibility with another ISP “ooo”, if it is possible to know the accessibility to which destinations is lost by the ISP “xxx”, it is possible to secure the stable accessibility to these destinations by utilizing the another ISP “ooo” with respect to them.

Normally, in the Internet, such an information regarding accessibility is exchanged through a routing control protocol. However, the sufficient routing control protocol can be hardly obtained from the ISP at a site that is under the contract with the ISP as an end-user. Most likely the common control information for all the destinations called a default route will be given. Also, there are cases where it is necessary to set up a default route manually regardless of the routing control protocol. In such cases, there has been a problem that it is impossible to know the network state of a particular ISP in detail by using the routing control protocol.

As described, conventionally, even when the reachability to a specific provider to the Internet is deteriorated at a site which is simultaneously accessing a plurality of ISPs, it has been difficult to comprehend that provider's state at the site side because the routing information given from the provider to the site is limited, unless the connection between the site and the provider is disconnected.

### BRIEF SUMMARY OF THE INVENTION

It is therefore an object of the present invention to provide a router device and an Internet service provider selection method capable of utilizing an Internet Service Provider with a higher accessibility at a higher priority by comprehending the accessing states of the Internet Service Providers, even under a situation where the information provided by the Internet Service Provider to the site is limited.

According to one aspect of the present invention there is provided a router device capable of accessing a plurality of Internet service providers that provide services for accessing Internet, comprising: a probe packet transmission unit configured to transmit a probe packet destined to a prescribed address on the Internet via each Internet service provider; a response packet receiving unit configured to receive a response packet in response to the probe packet; a judgement unit configured to judge accessibility of each Internet service provider according to a result of receiving the response packet; a storing unit configured to store information indicating the accessibility of each Internet service provider; and a selection unit configured to select one of the Internet service providers through which a received packet should be routed according to the information indicating the accessibility, upon receiving a packet that can be routed via more than one Internet service providers.

According to another aspect of the present invention there is provided an Internet service provider selection method at a router device capable of accessing a plurality of Internet service providers that provide services for accessing Internet, comprising: transmitting a probe packet destined to a prescribed address on the Internet via each Internet service provider; receiving a response packet in response to the probe packet; judging accessibility of each Internet service provider according to a result of receiving the response packet; storing information indicating the accessibility of each Internet service provider; and selecting one of the Internet service providers through which a received packet should be routed according to the information indicating the accessibility, upon receiving a packet that can be routed via more than one Internet service providers.

According to another aspect of the present invention there is provided a computer program product for causing a computer to function as a router device capable of accessing a plurality of Internet service providers that provide services for accessing Internet, the computer program product comprising: a first computer program code for causing the computer to transmit a probe packet destined to a prescribed address on the Internet via each Internet service provider; a second computer program code for causing the computer to receive a response packet in response to the probe packet; a third computer program code for causing the computer to judge accessibility of each Internet service provider according to a result of receiving the response packet; a fourth computer program code for causing the computer to store information indicating the accessibility of each Internet service provider; and a fifth computer program code for causing the computer to select one of the Internet service providers through which a received packet should be routed according to the information indicating the accessibility, upon receiving a packet that can be routed via more than one Internet service providers.

Other features and advantages of the present invention will become apparent from the following description taken in conjunction with the accompanying drawings.

### BRIEF DESCRIPTION OF THE DRAWINGS

FIG. 1 is a diagram showing an exemplary configuration of a network system according to one embodiment of the present invention.

FIG. 2 is a block diagram showing an exemplary configuration of a router according to one embodiment of the present invention.

FIG. 3 is a diagram showing an exemplary format of an ISP state table according to one embodiment of the present invention.

FIG. 4 is a diagram showing an exemplary format of a routing table according to one embodiment of the present invention.

FIG. 5 is a diagram showing an exemplary format of a next hop and ISP correspondence table according to one embodiment of the present invention.

FIG. 6 is a diagram showing an exemplary format of a destination cache according to one embodiment of the present invention.

FIG. 7 is a flow chart showing an exemplary processing procedure of a packet transfer processing unit in the router of FIG. 2.

FIG. 8 is a flow chart showing an exemplary processing procedure of an ISP state management unit in the router of FIG. 2.

FIG. 9 is a diagram showing another exemplary format of a destination cache according to one embodiment of the present invention.

FIG. 10 is a diagram showing a concrete example of a content of a destination cache according to one embodiment of the present invention.

FIG. 11 is a diagram showing another concrete example of a content of a destination cache according to one embodiment of the present invention.

FIG. 12 is a diagram showing a concrete example of a content of an ISP state table according to one embodiment of the present invention.

FIG. 13 is a diagram showing another concrete example of a content of a destination cache according to one embodiment of the present invention.

FIG. 14 is a diagram showing another concrete example of a content of a destination cache according to one embodiment of the present invention.

FIG. 15 is a diagram showing another concrete example of a content of a destination cache according to one embodiment of the present invention.

FIG. 16 is a diagram showing another concrete example of a content of an ISP state table according to one embodiment of the present invention.

### DETAILED DESCRIPTION OF THE INVENTION

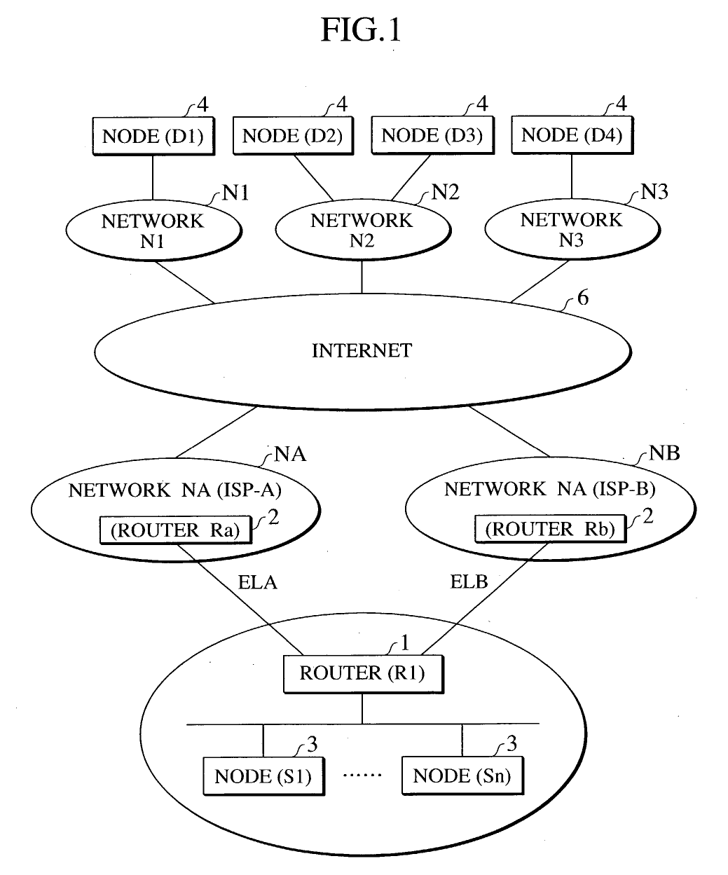

Referring now to FIG. 1 to FIG. 16, one embodiment of a router device and an Internet service provider selection method according to the present invention will be described in detail.

FIG. 1 shows an exemplary configuration of a network system according to one embodiment of the present invention, which comprises the Internet 6, a network NA, a network NB, a network NS, networks N1 to N3, and nodes 4.

The network NA is a network of an Internet Service Provider A (which will be abbreviated as ISP-A hereafter) that provides a service for accessing the Internet 6.

The network NB is a network of an Internet Service Provider B (which will be abbreviated as ISP-B hereafter) that provides a service for accessing the Internet 6.

The network NS is a site which is capable of accessing the Internet 6 through the network NA of the ISP-A or the network NB of the ISP-B (by making contracts with the ISP-A and the ISP-B).

Note that, in this example, the network NS can utilize two ISPs, but of course the present invention is equally applicable to the case where the contracts with three or more ISPs are made such that the network NS can utilize three or more ISPs.

As shown in FIG. 1, a router R1 with functions to be described in detail below exists in the network NS. This router R1 is a packet transfer device to be utilized in connecting the network NS and the ISP-A or in connecting the network NS and the ISP-B. Also, there are communication nodes 3 (such as computers, radio terminals, information home electronics, etc.) that belong to the network NS, and FIG. 1 shows an exemplary case where the communication node S1 to the communication node Sn are connected. In the following, the case of using the communication node (abbreviated as a node hereafter) S1 will be described, but the same description also is applicable to any one of the other communication nodes.

Note also that, in FIG. 1, ELA indicates a channel for connecting the network NS and the ISP-A, and ELB indicates a channel for connecting the network NS and the ISP-B. Also, from a viewpoint of the network NS, a next hop router 2 on the ISP-A's network NA side is referred to as Ra, and a next hop router 2 on the ISP-B's network NB side is referred to as Rb.

On the other hand, in FIG. 1, four nodes 4 with addresses D1 to D4 are shown as exemplary correspondents of the node S1. Here, the networks N1 to N3 are external networks that do not belong to any ISP, and it is assumed that the node D1 belongs to the network N1, the nodes N2 and N3 belong to the network N2, and the node D4 belongs to the network N3.

Note also that the network N1 may be a network of some ISP such that the node D1 is capable of accessing the Internet by making a contract with that ISP and utilizing the network N1. The same remark also applies to the nodes D2, D3, and D4 and the networks N2 and N3. Also, the node 4 that becomes the correspondent of the node S1 may be a multi-home user to which the present invention is applied, or a multi-home user to which the present invention is not applied. Also, the nodes D1 to D4 may be connected directly to the Internet 6 without using any networks.

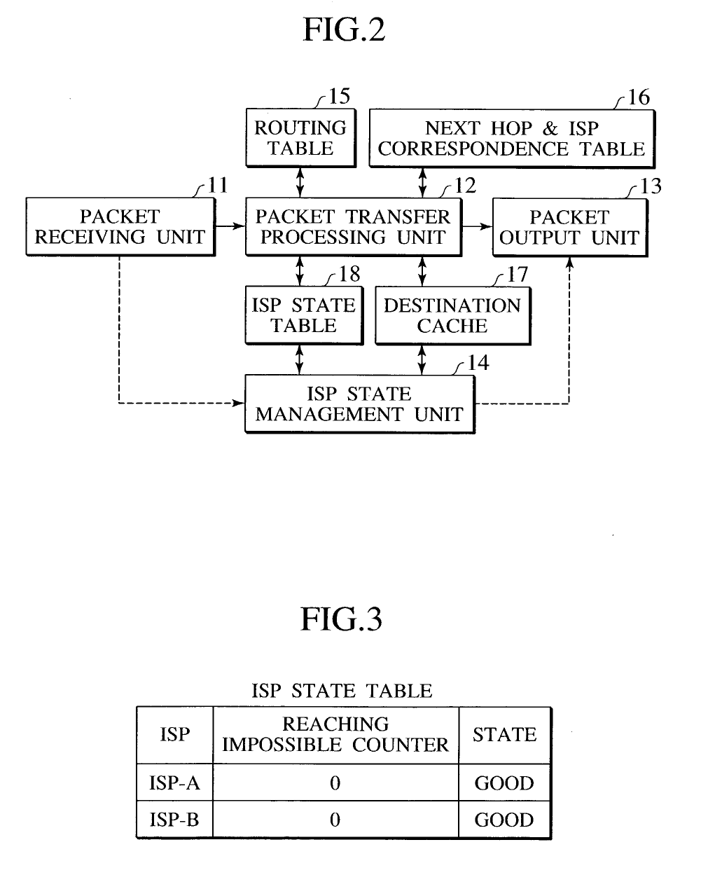

FIG. 2 shows an exemplary configuration of the router 1 according to one embodiment of the present invention.

As shown in FIG. 2, the router 1 of this embodiment has: a packet receiving unit 11 for receiving packets from the node 3 belonging to the network NS or to a side of each channel connected to the ISP (the ELA side or the ELB side in the example of FIG. 1); a packet transfer processing unit 12 for carrying out a processing for transferring packets such as a judgement regarding one of the ELA side and the ELB side to which the received packet should be transferred and an acquisition of information on which this judgement should be based; a packet output unit 13 for transmitting packets to the node 3 belonging to the network NS or to a side of each channel connected to the ISP (the ELA side or the ELB side in the example of FIG. 1); an ISP state management unit 14 for managing a state of each ISP (ISP-A and ISP-B in the example of FIG. 1); a routing table 15, a next hop and ISP correspondence table 16; a destination cache 17; and an ISP state table 18.

Note that the routing table 15, the next hop and ISP correspondence table 16, the destination cache 17, and the ISP state table 18 are stored in an appropriate storage device. Also, FIG. 2 omits to show a communication interface for making a connection to (a sub-network connected to) the node 3 belonging to the network NS or a communication interface for making a connection to (a channel connected to) each ISP.

Note that this router 1 can be realized in a form of a computer. In such a case, all or a part of the processing can be executed by a program, and all of a part of the processing can be executed by dedicated semiconductor integrated circuits.

FIG. 3 shows an exemplary format of the ISP state table 18. In this ISP state table 18, a “reaching impossible counter” and a “state” are maintained for each ISP that can possibly be selected. The “state” indicates an evaluation regarding the reachability of that ISP, which is assumed to take a value of either “good” or “bad” in this embodiment. The “reaching impossible counter” provides a material for judging the “state”, which is updated according to the result of transmitting a state probe packet through that ISP periodically by the ISP state management unit 14, as will be described in detail below.

The judgement of the “state” can be made by regarding that ISP as having “state”=“good” when the reaching impossible counter has a value less than a reference value C, and regarding that ISP as having “state”=“bad” when the reaching impossible counter has a value greater than or equal to C. for example. In the following, the exemplary case of using C=2 will be described.

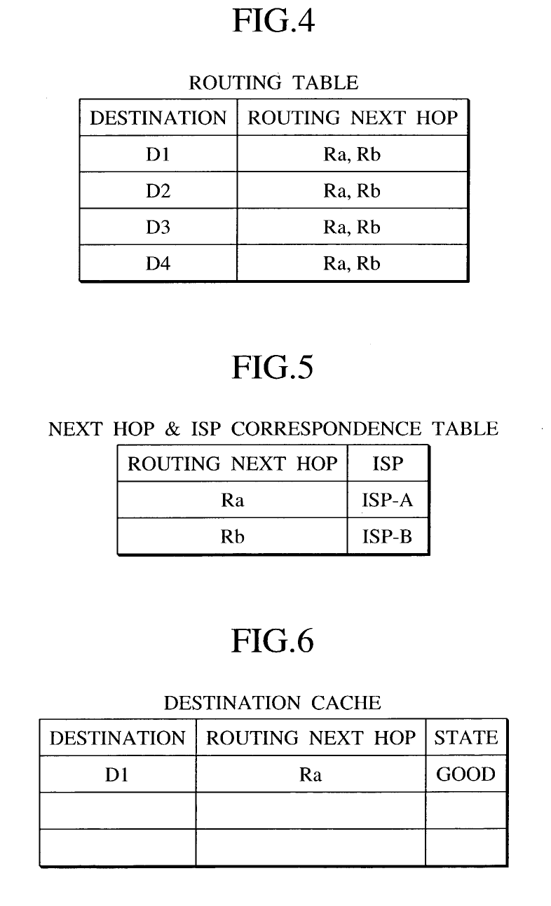

FIG. 4 shows an exemplary format of the routing table 15. In this routing table 15, a default routing next hop (address of a next hop router) is registered for each destination. In the example of FIG. 4, the routing next hops of all the contracted ISPs, i.e., a next hop router Ra on the ISP-A side and a next hop router on the ISP-B side, are registered for each destination. Note that it is also possible to selectively register only a part of the routing next hops of the contracted ISPs for each destination (such that D1 can use only Ra, for example).

FIG. 5 shows an exemplary format of the next hop and ISP correspondence table 16. In this next hop and ISP correspondence table, a corresponding ISP is registered for each routing next hop (address of a next hop router) that can possibly be selected. Namely, it is possible to obtain the corresponding ISP from the routing next hop, by referring to the next hop and ISP correspondence table 16.

FIG. 6 shows an exemplary format of the destination cache 17. This destination cache 17 caches a set of a “destination (address)”, a next hop of the ISP selected for that destination, and a “state” of that ISP with respect to that destination. Note that the “state” here is updated according to the result of transmitting a state probe packet to that destination through that ISP periodically by the ISP state management unit 14, as will be described in detail below, which is different from the “state” of the ISP state table 18.

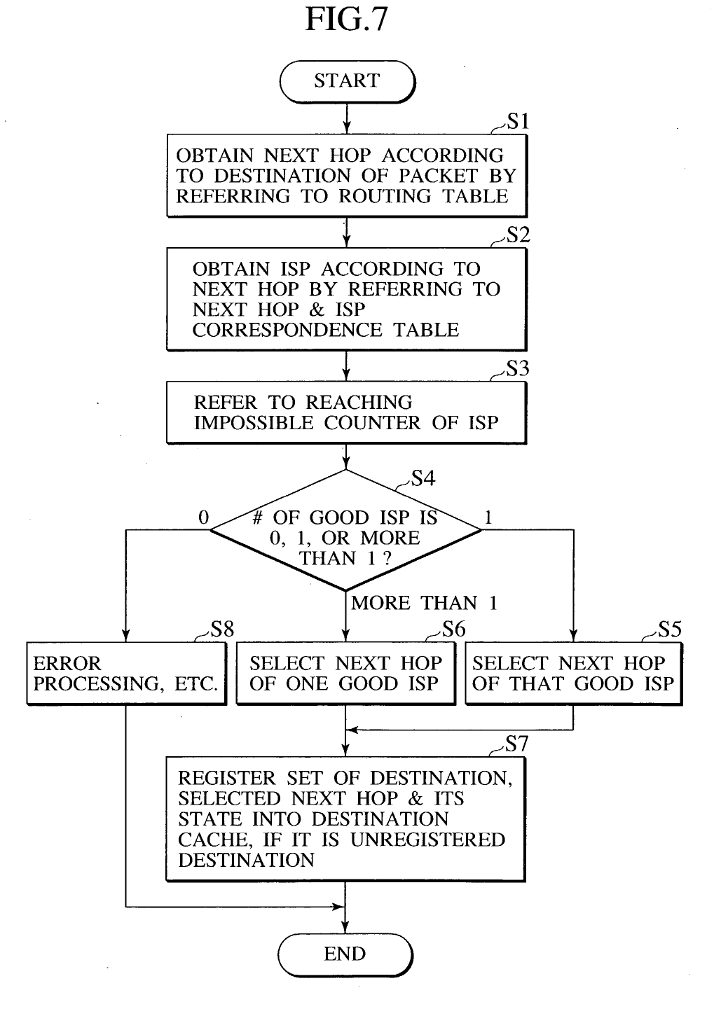

FIG. 7 shows an exemplary processing procedure for the ISP selection and the registration into the destination cache 17, when a packet to a node (D1, for example) to become a correspondent is received through the Internet 6 from a node (S1, for example) belonging to the network NS at the packet transfer processing unit 12 of the router 1 in the network NS.

First, by referring to the routing table 15 (see FIG. 4), all the default routing next hops are obtained according to the destination of the packet (step Si).

Then, by referring to the next hop and ISP correspondence table 16 (see FIG. 5), the corresponding ISP of each next hop obtained by the step S1 is obtained (step S2).

Then, by referring to the ISP state table 18 (see FIG. 3), the “state” is obtained for each ISP obtained by the step S2 (step S3).

Then, if the number of ISPs with “state”=“good” among the ISPs obtained by the step S2 is zero, one, or more than one is judged (step S4).

When the number Judged at the step S4 is one, the next hop of that ISP with “state”=“good” is selected (step S5). When the number Judged at the step S4 is more than one, the next hop of one ISP selected from those ISPs with “state”=“good” according to a prescribed selection method is selected (step S6). Note that various methods can be used as the prescribed selection method, including a method for selecting randomly, a method for selecting one with the smaller value of the reaching impossible counter, a method for selecting one with the smaller total number of times by which it is registered into the destination cache, a method for setting a priority level of the ISP for each destination in advance and selecting the ISP with the higher priority level, a method combining any of the above described methods, etc.

When the next hop of one ISP is selected at the step S5 or the step S6, and if that destination is not yet registered in the destination cache 17 (see FIG. 6), a set of the destination, the next hop of the selected ISP, and its state is registered into the destination cache 17. At this point, the state is set to be “good”.

However, in the case where that destination is already registered in the destination cache 17, that entry in the destination cache 17 is not updated. Note that, in this case, if the entry with the identical destination and a different next hop is already registered, it is also possible to register another entry with the identical destination, the newly selected next hop and “state”=“good” (there will be a plurality of entries with the identical destination as a result).

In the case where the number of ISPs with “state”=“good” among the ISPs obtained by the step S2 is zero at the step S4, one ISP among the ISPs obtained by the step S2 (which all have “state”=“bad” in this case) can be selected according to a prescribed selection method, and the processing similar to the step S7 can be carried out. Note that the prescribed selection method can be any of the various methods mentioned in relation to the step S6. Here, the same selection method as that of the step S6 may be adopted, or the selection method different from that of the step S6 may be adopted.

In the case where the number of ISPs with “state”=“good” is zero, it is also possible to carry out the error processing such as the interruption of the transfer, for example. It is also possible to use a method in which the packet is held for a prescribed period of time, and if there is an ISP for which a transition to “state”=“good” occurs before the prescribed period of time elapses, that ISP is selected and the processing similar to the step S7 is carried out, and if there is no ISP for which a transition to “state”=“good” occurs before the prescribed period of time elapses, the error processing such as the interruption of the transfer is carried out, for example. Besides these, many other methods for handling this case are possible.

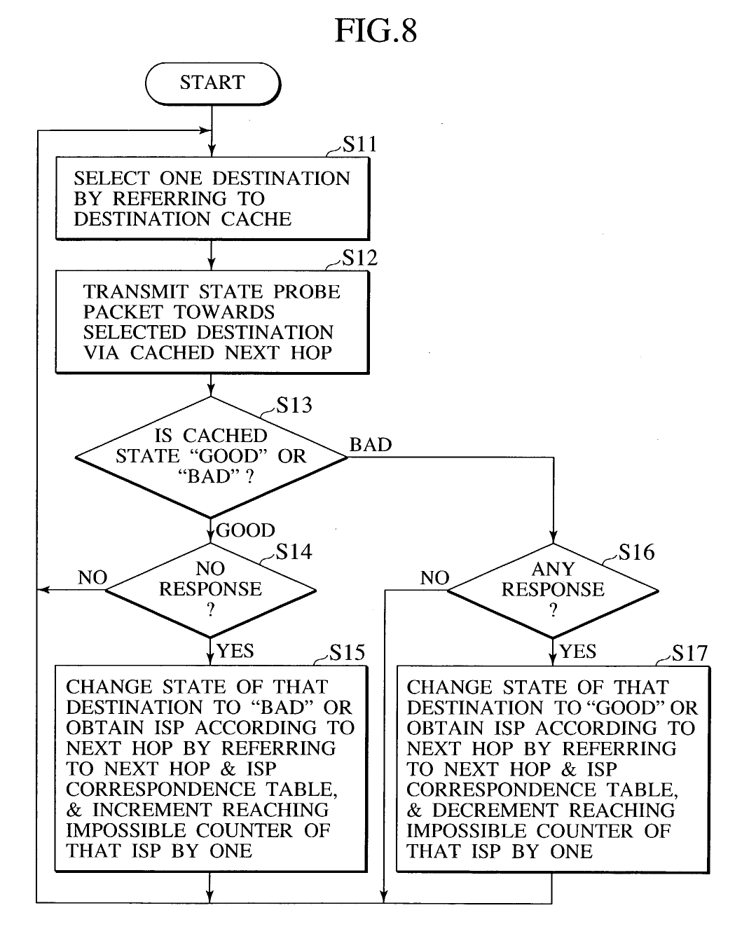

FIG. 8 shows an exemplary processing procedure for updating the destination cache 17 and the ISP state table 18 according to a result of transmitting the state probe packet periodically at the ISP state management unit 14 of the router 1 in the network NS.

The ISP state management unit 14 transmits the state probe packet toward each destination registered in the destination cache 17 (see FIG. 6), periodically via the next hop registered for that destination, and updates the destination cache 17 and the ISP state table 18 (see FIG. 3) according to that result.

Namely, first, by referring to the destination cache 17, one destination to which the state probe packet should be transmitted is selected (step S11).

Then, the state probe packet is transmitted toward the selected destination via the next hop cached for that destination (step S12).

The subsequent processing is different depending on the “state” cached for that destination and that next hop.

In the case where “state”=“good” is cached for that destination and that next hop (step S13 GOOD), and if there is no response to the above described state probe packet (within a prescribed period of time) (step S14 YES), the state of that destination is changed to “bad”, and the ISP to which the next hop cached for that destination belongs is obtained by referring to the next hop and ISP correspondence table 16 (see FIG. 5) and the value of the “reaching impossible counter” corresponding to that ISP is incremented by one in the ISP state table 18 (step S15). Note that, in this case, if there is a response to the above described state probe packet (within a prescribed period of time) (step S14 NO), nothing will be done.

On the other hand, in the case where “state”=“bad” is cached for that destination and that next hop (step S13 BAD), and if there is a response to the above described state probe packet (within a prescribed period of time) (step S16 YES), the state of that destination is changed to “good”, and the ISP to which the next hop cached for that destination belongs is obtained by referring to the next hop and ISP correspondence table 16 and the value of the “reaching impossible counter” corresponding to that ISP is decremented by one in the ISP state table 18 (step S17). Note that, in this case, if there is no response to the above described state probe packet (within a prescribed period of time) (step S16 NO), nothing will be done.

Here, at the step S15, in the case where the value of the reaching impossible counter is less than the reference value C at a time of transmitting the state probe packet but the value of the reaching impossible counter becomes greater than or equal to C as a result of incrementing the value of the reaching impossible counter by one, the ISP state management unit 14 changes the state of that ISP to “bad”. Also, at the step S17, in the case where the value of the reaching impossible counter is greater than or equal to the reference value C at a time of transmitting the state probe packet but the value of the reaching impossible counter becomes less than C as a result of decrementing the value of the reaching impossible counter by one, the ISP state management unit 14 changes the state of that ISP to “good”.

Alternatively, it is also possible to use a method in which the “state” field is not provided, and whether the state is “good” or “bad” is judged according to whether the value of the reaching impossible counter is less than C or not by referring to that reaching impossible counter, when the packet transfer processing unit 12 refers to the ISP state table 18.

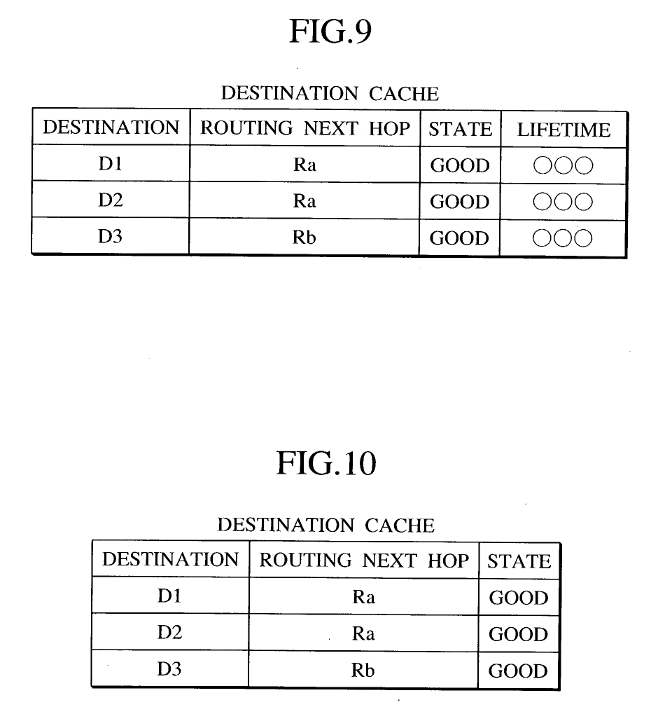

As a method for managing a timing for transmitting the state probe packet, it is possible to use the following method, for example. Namely, as shown in FIG. 9, a lifetime field is provided in the destination cache 17, and then at a prescribed timing such as that of the last time the state probe packet was transmitted (or when the presence/absence of the response to the state probe packet is ascertained, or when the presence/absence of the update of the state field is ascertained), a prescribed lifetime value (such as year, month, day, hour, minute and second at which the valid period of that entry expires, for example) is written into the corresponding lifetime field, and if there is a destination for which a prescribed condition such as the expiration of the lifetime (or a time until the expiration of the lifetime becomes less than a reference value) is satisfied, the state probe packet is transmitted to that destination and the destination cache 17 and the ISP state table 18 are updated according to that result. Besides this, many other methods are possible.

Note that each entry of the destination cache 17 can be deleted or overwritten at appropriate timing. For example, it is possible to delete an entry for which a prescribed period of time has elapsed since it is registered. It is also possible to overwrite an old entry selected according to a prescribed rule such as “first in first out” by a new entry when the overflow of entries occurs at the destination cache.

Note however that it is preferable to avoid the contradiction between the “state” of each entry in the destination cache 17 and each “reaching impossible counter” in the ISP state table 18. This can be achieved by prohibiting the deletion or the overwriting of an entry with “state”=“bad” in the destination cache 17. This can also be achieved by allowing the deletion or the overwriting of an entry with “state”=“bad” in the destination cache 17 when the state in the ISP state table 18 of the ISP corresponding to the next hop of that entry is not changed to “good”, and decrementing the value of the corresponding reaching impossible counter in the ISP state table 18 by one. This can also be achieved by allowing the deletion or the overwriting of an entry with “state”=“bad” in the destination cache 17, decrementing the value of the corresponding reaching impossible counter in the ISP state table 18 of the ISP corresponding to the next hop of that entry by one, and updating the corresponding state in the ISP state table 18 to “good” if the value of the corresponding reaching impossible counter becomes less than the reference value C as a result of the decrementing.

Also, at a time of deleting or overwriting one of the entries maintained in the destination cache 17, it is preferable to select an entry to be deleted or overwritten as an entry belonging to one of the groups that contain more entries than a prescribed number of entries, when the entries are grouped such that those entries having the next hop of the identical ISP belong to the same group. In this way, in the case where once entries regarding one ISP are maintained in the destination cache 17, even if the deletion or the overwriting of the entry occurs subsequently, it is possible to prevent the deletion of all these entries regarding that one ISP. Note that the prescribed number of entries can be a common value regardless of ISPs or it can be set up for each ISP separately.

Also, after the destination cache 17 is cleared for some reason, it may takes some time until packets are transferred via all the ISPs. For this reason, the router 1 can voluntarily transfer some packets to a prescribed destination via those ISPs for which the corresponding entries are not maintained in the destination cache 17 by the time a prescribed period of time has elapsed since the destination cache 17 was cleared, for example, such that the corresponding entries will be maintained in the destination cache 17 for all the ISPs and the state probe packets will be transmitted via all the ISPs.

In the following, this embodiment will be described in further detail by using a concrete example.

First, in FIG. 1, suppose that it is in a state where the good accessibility can be provided to both of the ISP-A and the ISP-B. Namely, as in an example of the ISP state table 18 shown in FIG. 3, suppose that “state”=“good” for both of the ISP-A and the ISP-B (here it is assumed that the ISP with the reaching impossible counter greater than or equal to two will be regarded as “bad”).

Also, suppose that the next hop and ISP correspondence table 16 is as shown in FIG. 5, and the routing table 15 is as shown in FIG. 4, while the destination cache 17 has a format as shown in FIG. 6 but it is currently empty.

Now, in this state, suppose that the node S1 transmits a packet to the node D1.

Then, the router R1 receives this packet at the packet receiving unit 11 first, and sends it to the packet transfer processing unit 12.

The packet transfer processing unit 12 searches through the routing table 15 according to the destination of the packet. In the example shown in FIG. 4, two default routing next hops Ra and Rb will be found as those matching to the destination D1.

Next, the packet transfer processing unit 12 obtains the ISP corresponding to each of the routing next hops Ra and Rb, from the next hop and ISP correspondence table 16. In the example shown in FIG. 5, ISP-A is obtained for Ra and ISP-B is obtained for Rb.

Next, the states of the ISP-A and the ISP-B are obtained by referring to the ISP state table 18. In the example shown in FIG. 3, the “state”=“good” is obtained for both the ISP-A and the ISP-B.

Consequently, in this case, either one of the next hop Ra on the ISP-A side and the next hop Rb on the ISP-B side is selected according to the prescribed selection method. Here, it is assumed that the next hop Ra on the ISP-A side is selected.

Then, if it is an unregistered destination, the packet transfer processing unit 12 newly registers a set of the destination, the selected next hop and the state (=“good”) into the destination cache 17. At this point, the state of the destination cache 17 becomes as shown in FIG. 6.

Then, the packet transfer processing unit 12 sends that packet to the packet output unit 13. The packet output unit 13 transmits the packet toward the above described selected next hop Ra.

Next, in this state, suppose that the node S1 transmits packets to the nodes D2 and D3, and by the similar procedure, the next hop Ra of the ISP-A is selected for the node D2 and the next hop Rb of the ISP-B is selected for the node D3. At this point, the state of the destination cache 17 becomes as shown in FIG. 10. As a result, the packet destined to the node D2 is transmitted toward the next hop Ra and the packet destined to the node D3 is transmitted toward the next hop Rb.

Here, suppose that the fault occurs on the network of the ISP-A such that the reachability to the nodes D1 and D2 via the ISP-A is lost.

At this point, the ISP state management unit 14 updates the destination cache 17 and the ISP state table 18 as follows.

First, for the node D1, as the state is “good” in the destination cache 17, the state probe packet is transmitted via the next hop Ra cached in the destination cache 17, and as a response is not received, the state of the destination D1 is changed to “bad” in the destination cache 17, while the ISP-A to which the next hop of that destination D1 belongs is obtained (from the next hop and ISP correspondence table 16) and the value of the “reaching impossible counter” corresponding to that ISP-A in the ISP state table 18 is incremented by one. Similarly, for the node D2, the state of the destination D2 is changed to “bad” in the destination cache 17, while the value of the “reaching impossible counter” corresponding to that ISP-A in the ISP state table 18 is incremented by one. As a result, the value of the “reaching impossible counter” corresponding to the ISP-A in the ISP state table 18 becomes two.

Namely, by the periodical probe packet transmission to the destinations D1 and D2 by the ISP state management unit 14, the loss of the reachability to the nodes D1 and D2 via the ISP-A is recognized, and the states of D1 and D2 in the destination cache 17 are changed from “good” to “bad”, and as a result, the reaching impossible counter of the ISP-A is updated to “2”.

Note that here the state corresponding to the ISP-A in the ISP state table 18 is updated to “bad” because the value of the reaching impossible counter became greater than or equal to the reference value “2”.

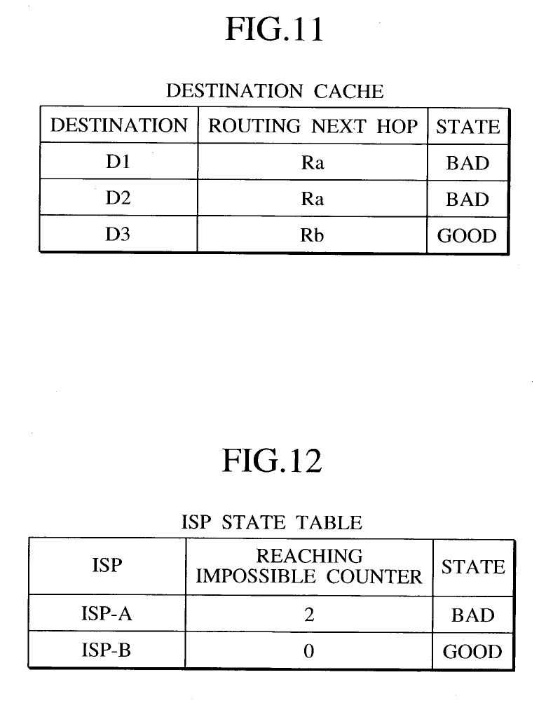

At this point, the state of the destination cache 17 becomes as shown in FIG. 11. Also, the content of the ISP state table 18 becomes as shown in FIG. 12.

Note that, for the node D3, as the state is “good” in the destination cache 17, the state probe packet is transmitted via the next hop Rb cached in the destination cache 17, and a response is received, so that the contents of the destination cache 17 and the ISP state table 18 are unaffected.

Namely, when the transmission of the state probe packets to these nodes D1 to D3 and the update processing based on the result are completed, the state of the destination cache 17 becomes as shown in FIG. 11.

Note that, after the state is updated to “bad” in the destination change 17 for the nodes D1 and D2, a response will not be received even when the state probe packet is transmitted, so that the contents of the destination cache 17 and the ISP state table 18 are unaffected.

Now, in this state, suppose that the node S1 transmits a packet to the node D4.

Then, the router R1 receives this packet at the packet receiving unit 11 first, and sends it to the packet transfer processing unit 12.

The packet transfer processing unit 12 searches through the routing table 15 according to the destination of the packet, and obtains two default routing next hops Ra and Rb. Next, the packet transfer processing unit 12 obtains the ISP-A and the ISP-B corresponding to these routing next hops Ra and Rb, from the next hop and ISP correspondence table 16. Then, the state of the ISP-A “bad” and the state of the ISP-B “good” are obtained by referring to the ISP state table 18.

Consequently, in this case, the next hop Rb on the ISP-B side is selected because the ISP-B is the only ISP with “state”=“good”.

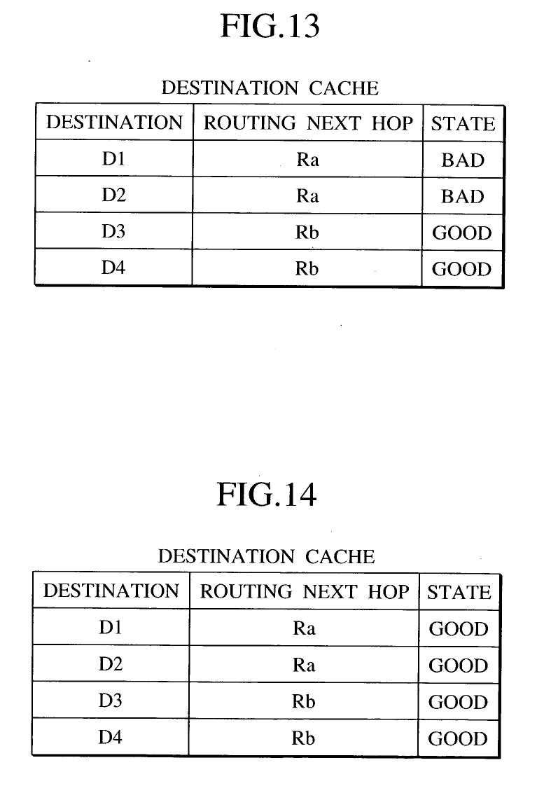

Then, if it is an unregistered destination, the packet transfer processing unit 12 newly registers a set of the destination, the selected next hop and the state (=“good”) into the destination cache 17. At this point, the state of the destination cache 17 becomes as shown in FIG. 13.

Then, the packet transfer processing unit 12 sends that packet to the packet output unit 13. The packet output unit 13 transmits the packet toward the above described selected next hop Rb.

Here, suppose that the network of the ISP-A recovers from the fault such that the reachability to the nodes D1 and D2 via the ISP-A is recovered.

At this point, the ISP state management unit 14 updates the destination cache 17 and the ISP state table 18 as follows.

First, for the node D1, as the state is “bad” in the destination cache 17, the state probe packet is transmitted via the next hop Ra cached in the destination cache 17, and as a response is received, the state of the destination D1 is changed to “good” in the destination cache 17, while the ISP-A to which the next hop of that destination D1 belongs is obtained (from the next hop and ISP correspondence table 16) and the value of the “reaching impossible counter” corresponding to that ISP-A in the ISP state table 18 is decremented by one. Similarly, for the node D2, the state of the destination D2 is changed to “good” in the destination cache 17, while the value of the “reaching impossible counter” corresponding to that ISP-A in the ISP state table 18 is decremented by one. As a result, the value of the “reaching impossible counter” corresponding to the ISP-A in the ISP state table 18 becomes zero, and the corresponding “state” is changed from “bad” to “good”.

At this point, the state of the destination cache 17 becomes as shown in FIG. 14. Also, the content of the ISP state table 18 becomes as shown in FIG. 3.

Note that, in the case where the node S1 transmits a packet to the node D1 (that has been using the ISP-A) under the state in which the reachability to the nodes D1 and D2 via the ISP-A is lost as the fault occurred on the network of the ISP-A, the ISP-B with “state”=“good” can be selected.

On the other hand, suppose that the faults occur on both the network of the ISP-A and the network of the ISP-B under the state in which the state of the destination cache 17 is as shown in FIG. 13 and the state of the ISP state table 18 is as shown in FIG. 12, such that the reachability to the nodes D1 and D2 via the ISP-A and the reachability to the nodes D3 and D4 via the ISP-B are both lost.

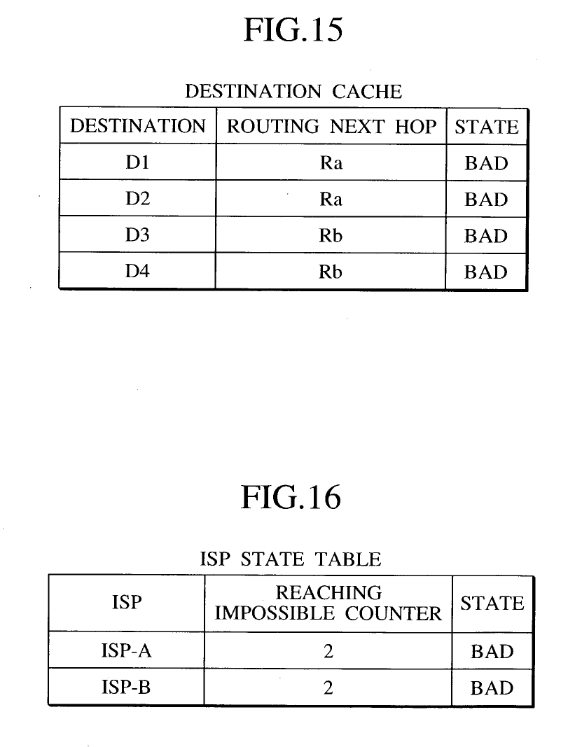

At this point, the state of the destination cache 17 becomes as shown in FIG. 15. Also, the content of the ISP state table 18 becomes as shown in FIG. 16.

Now, in this state, suppose that the node SI transmits a packet to the node D5 (not shown).

Then, the router RI receives this packet at the packet receiving unit 11 first, and sends it to the packet transfer processing unit 12.

The packet transfer processing unit 12 searches through the routing table 15 according to the destination of the packet, and obtains two default routing next hops Ra and Rb. Next, the packet transfer processing unit 12 obtains the ISP-A and the ISP-B corresponding to these routing next hops Ra and Rb, from the next hop and ISP correspondence table 16. Then, the state of the ISP-A “bad” and the state of the ISP-B “bad” are obtained by referring to the ISP state table 18.

Consequently, in this case, the number of ISPs with “state”=“good” is zero, so that it is assumed here that the ISP-A is selected according to a prescribed selection method.

Then, if it is an unregistered destination, the packet transfer processing unit 12 newly registers a set of the destination, the selected next hop and the state (=“good”) into the destination cache 17. Note that although “state”=“good” is registered here, if the ISP-A is not recovered yet, it will be updated to “state”=“bad” by the transmission of a next state probe packet.

Then, the packet transfer processing unit 12 sends that packet to the packet output unit 13. The packet output unit 13 transmits the packet toward the above described selected next hop Ra.

Note that, as described above, in the case where the number of ISPs with “state”=“good” is zero, it is possible to interrupt the packet transfer to the ISP until one or more ISP with “state”=“good” recovers, or it is possible to maintain the packet for a prescribed period of time such that if there is an ISP for which the state is changed to “good” before the prescribed period of time, that ISP can be selected.

Here, in the case where only the network of the ISP-B is recovered from the fault among the network of the ISP-A and the network of the ISP-B, the content of the ISP state table 18 has “state”=“bad” for the ISP-A and “state”=“good” for the ISP-B. The procedure in the case where the node S1 transmits a packet to the node D6 (not shown) under this state is the same as the procedure described above in the case where the node S1 transmits a packet to the node D4.

As described, according to the present invention, it becomes possible utilize an Internet Service Provider with a higher accessibility at a higher priority by comprehending the accessing states of the Internet Service Providers, even under a situation where the information provided by the Internet Service Provider to the site is limited.

According to the present invention, even in the case where a sufficient routing information cannot be obtained from the Internet Service Provider at a site that is accessing a plurality of the Internet Service Providers simultaneously, the accessibility of each Internet Service Provider can be checked by the appropriate polling, so that it becomes possible to utilize an Internet Service Provider with a higher accessibility at a higher priority.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the router device of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A router device capable of accessing a plurality of Internet service providers that provide services for accessing Internet, comprising:
a probe packet transmission unit configured to transmit a probe packet destined to a prescribed address on the Internet via each Internet service provider;
a response packet receiving unit configured to receive a response packet in response to the probe packet;
a judgement unit configured to judge accessibility of each Internet service provider according to a result of receiving the response packet;
a storing unit configured to store information indicating the accessibility of each Internet service provider; and
a selection unit configured to select one of the Internet service providers through which a received packet should be routed according to the information indicating the accessibility, upon receiving a packet that can be routed via more than one Internet service providers.

2. The router device of claim 1, wherein the storing unit stores the information that indicates either good or bad, and the selection unit selects one Internet service provider for which the information stored in the storing unit indicates good.

3. The router device of claim 2, further comprising:
a memory unit configured to store information regarding those Internet service providers through which a received packet with a specified destination address can be routed for each specified destination address;
wherein the selection unit selects the one Internet service provider from those Internet service providers whose information is stored in the memory unit with respect to a destination address of the received packet.

4. The router device of claim 1, wherein the selection unit selects the one of the Internet service providers according to a prescribed selection method when more than one Internet service providers for which the information stored in the storing unit indicates good are available.

5. The router device of claim 1, wherein the probe packet transmission unit transmits probe packets with different destination addresses for each Internet service provider via each Internet service provider, and the judgement unit changes the information indicating the accessibility of each Internet service provider as good when a total number of destination addresses from which response packets in response to the probe packets are not received is less than a prescribed reference value, or changes the information indicating the accessibility of each Internet service provider as bad when a total number of destination addresses from which response packets in response to the probe packets are not received is greater than or equal to the prescribed reference value.

6. The router device of claim 1, further comprising a destination cache unit configured to cache entries each of which contains information regarding a particular destination address to be given to each probe packet and a particular Internet service provider through which each probe packet with the particular destination address should be routed, and information indicating whether the response packet in response to each probe packet is received or not when each probe packet with the particular destination address was transmitted via the particular Internet service provider for last time, and
wherein the probe packet transmission unit transmits each probe packet with the particular destination address via the particular Internet service provider according to a content of an entry in the destination cache unit.

7. The router device of claim 6, wherein the probe packet transmission unit periodically carries out transmission of each probe packet with the particular destination address via the particular Internet service provider.

8. The router device of claim 6, wherein each entry of the destination cache unit also contains information regarding a valid period of that each entry, and the probe packet transmission unit periodically carries out transmission of each probe packet with the particular destination address via the particular Internet service provider according to the information regarding the valid period.

9. The router device of claim 6, wherein the destination cache unit cache each entry that contains the information regarding the particular destination address to be given to each probe packet and the particular Internet service provider through which each probe packet with the particular destination address should be routed, that is set according to a destination address of an actually transferred packet and an Internet service provider through which the actually transferred packet is routed.

10. The router device of claim 6, wherein at a time of deleting or overwriting one of the entries maintained in the destination cache unit, an entry to be deleted or overwritten is selected as an entry belonging to one of groups that contain more entries than a prescribed number of entries, when the entries are grouped such that those entries having information regarding an identical Internet service provider belong to a same group.

11. The router device of claim 1, wherein the selection unit selects the one of the Internet service providers according to a prescribed selection method from more than one Internet service providers that can be selected if the information stored in the storing unit indicates good, when the information stored in the storing unit indicates bad for all Internet service providers that can be selected if the information stored in the storing unit indicates good.

12. The router device of claim 1, wherein the selection unit waits for a prescribed period of time to see if the information stored in the storing unit changes from bad to good for any Internet service provider, and selects the one of the Internet service providers as an Internet service provider for which the information stored in the storing unit is changed from bad to good within the prescribed period of time, when the information stored in the storing unit indicates bad for all Internet service providers that can be selected if the information stored in the storing unit indicates good.

13. The router device of claim 1, further comprising:
a plurality of first communication units configured to access respective ones of the plurality of the Internet service providers, such that the probe packet transmission unit transmits the probe packet destined to a prescribed device capable of transferring the probe packet through the Internet in order to check the accessibility of each Internet service provider through one of the first communication units corresponding to each Internet service provider, and the response packet receiving unit receives the response packet in response to the probe packet from the prescribed device from the one of the first communication units corresponding to each Internet service provider;
a second communication unit configured to access a node device within a same network;
a packet transfer unit configured to transfer packets bidirectionally through the first communication units and the second communication unit;
a next hop selection unit configured to obtain a next hop corresponding to a destination address of the received packet, obtain a specific Internet service provider corresponding to the next hop, and select the next hop corresponding to the specific Internet service provider through which the received packet to be transferred through the Internet that is received by the second communication unit should be routed in order to access the Internet; and
a cache unit configured to cache an entry which contains the destination address of the received packet and the next hop selected for the destination address.

14. An Internet service provider selection method at a router device capable of accessing a plurality of Internet service providers that provide services for accessing Internet, comprising:
transmitting a probe packet destined to a prescribed address on the Internet via each Internet service provider;
receiving a response packet in response to the probe packet;
judging accessibility of each Internet service provider according to a result of receiving the response packet;
storing information indicating the accessibility of each Internet service provider; and
selecting one of the Internet service providers through which a received packet should be routed according to the information indicating the accessibility, upon receiving a packet that can be routed via more than one Internet service providers.

15. The Internet service provider selection method of claim 14, wherein the router device further comprises a plurality of first communication units configured to access respective ones of the plurality of the Internet service providers, a second communication unit configured to access a node device within a same network, and a packet transfer unit configured to transfer packets bidirectionally through the first communication units and the second communication unit, such that the transmitting step transmits the probe packet destined to a prescribed device capable of transferring the probe packet through the Internet in order to check the accessibility of each Internet service provider through one of the first communication units corresponding to each Internet service provider, and the receiving step receives the response packet in response to the probe packet from the prescribed device from the one of the first communication units corresponding to each Internet service provider, and
the Internet service provider selection method further comprises:
obtaining a next hop corresponding to a destination address of the received packet, obtaining a specific Internet service provider corresponding to the next hop, and selecting the next hop corresponding to the specific Internet service provider through which the received packet to be transferred through the Internet that is received by the second communication unit should be routed in order to access the Internet; and
caching an entry which contains the destination address of the received packet and the next hop selected for the destination address.

16. A computer program product for causing a computer to function as a router device capable of accessing a plurality of Internet service providers that provide services for accessing Internet, the computer program product comprising:
a first computer program code for causing the computer to transmit a probe packet destined to a prescribed address on the Internet via each Internet service provider;
a second computer program code for causing the computer to receive a response packet in response to the probe packet;
a third computer program code for causing the computer to judge accessibility of each Internet service provider according to a result of receiving the response packet;
a fourth computer program code for causing the computer to store information indicating the accessibility of each Internet service provider; and
a fifth computer program code for causing the computer to select one of the Internet service providers through which a received packet should be routed according to the information indicating the accessibility, upon receiving a packet that can be routed via more than one Internet service providers.

17. The computer program product of claim 16, wherein the router device also has a plurality of first communication units configured to access respective ones of the plurality of the Internet service providers, a second communication unit configured to access a node device within a same network, and a packet transfer unit configured to transfer packets bidirectionally through the first communication units and the second communication unit, such that the first computer program code causes the computer to transmit the probe packet destined to a prescribed device capable of transferring the probe packet through the Internet in order to check the accessibility of each Internet service provider through one of the first communication units corresponding to each Internet service provider, and the second computer program code causes the computer to receive the response packet in response to the probe packet from the prescribed device from the one of the first communication units corresponding to each Internet service provider, and
the computer program product further comprises:
a sixth computer program code for causing the computer to obtain a next hop corresponding to a destination address of the received packet, obtain a specific Internet service provider corresponding to the next hop, and select the next hop corresponding to the specific Internet service provider through which the received packet to be transferred through the Internet that is received by the second communication unit should be routed in order to access the Internet; and
a seventh computer program code for causing the computer to cache an entry which contains the destination address of the received packet and the next hop selected for the destination address.
